(19) United States
(12) Patent Application Publication
(10) Pub. No.: US 2024/0170719 A1
(43) Pub. Date: May 23, 2024

(54) ROLL-TO-ROLL HOT CASTING OF FREE-STANDING GEL MEMBRANE FOR BATTERY CELLS

(71) Applicant: GM GLOBAL TECHNOLOGY OPERATIONS LLC, Detroit, MI (US)

(72) Inventors: Zhe LI, Shanghai (CN); Qili SU, Shanghai (CN); Meiyuan WU, Shanghai (CN); Haijing LIU, Shanghai (CN); Mengyan HOU, Shanghai (CN)

(21) Appl. No.: 18/363,052

(22) Filed: Aug. 1, 2023

(30) Foreign Application Priority Data
Nov. 9, 2022 (CN) 202211399417.0

(51) Int. Cl. H01M 10/0565; H01M 10/0585; H01M 50/403; H01M 50/42

(52) U.S. Cl. CPC H01M 10/0565; H01M 10/0585; H01M 50/403; H01M 50/42; H01M 2300/0037; H01M 2300/0085

(57) ABSTRACT

A method for manufacturing a gel membrane for a battery cell includes supplying a first substrate to a first roller; heating a gel membrane solution in a tank, wherein the gel membrane solution includes a polymer and a liquid electrolyte comprising one or more lithium salts; arranging a slot die within a predetermined distance of the first substrate located on the first roller; pumping the gel membrane solution into an inlet of the slot die; depositing a gel membrane layer from an outlet of the slot die onto the first substrate supported by the first roller; and cooling the gel membrane layer on the first substrate.

### CROSS-REFERENCE TO RELATED APPLICATIONS

This application claims the benefit of Chinese Patent Application No. 202211399417.0, filed on Nov. 9, 2022. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a gel membrane for a battery cell and a method for roll-to-roll hot casting of the gel membrane.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased energy density to increase the range of the EVs.

Lithium-ion battery (LIB) cells are currently used for high power density or high energy density applications. Solid-state battery (SSB) cells with solid electrolyte have improved characteristics as compared to LIB cells in terms of abuse tolerance and working temperature range. However, high volume manufacturing of the SSB with the solid electrolyte has proven to be challenging.

### SUMMARY

A method for manufacturing a gel membrane for a battery cell includes supplying a first substrate to a first roller; heating a gel membrane solution in a tank, wherein the gel membrane solution includes a polymer and a liquid electrolyte comprising one or more lithium salts; arranging a slot die within a predetermined distance of the first substrate located on the first roller; pumping the gel membrane solution into an inlet of the slot die; depositing a gel membrane layer from an outlet of the slot die onto the first substrate supported by the first roller; and cooling the gel membrane layer on the first substrate.

In other features, a gap between the outlet of the slot die and the first substrate is in a range from 1 μm to 100 μm. The method includes arranging a second substrate over an exposed surface of the gel membrane layer. The polymer is in a range from 10 to 50 wt % of the gel membrane solution and the liquid electrolyte is in a range from 50 to 90 wt % of the gel membrane solution.

In other features, the polymer is selected from a group consisting of poly(ethylene oxide) (PEO), poly(vinylidene fluoride-co-hexafluoropropylene) (PVdF-HFP), poly(methyl methacrylate) (PMMA), carboxymethyl cellulose (CMC), polyacrylonitrile (PAN), polyvinylidene difluoride (PVDF), poly(vinyl alcohol) (PVA), and polyvinylpyrrolidone (PVP).

In other features, the liquid electrolyte comprises a dual lithium salt, a solvent, and an electrolyte additive. The dual lithium salt comprises at least one lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalate)borate (DFOB), and bis(fluoromalonato)borate (BFMB).

In other features, the solvent is selected from a group consisting of carbonate solvents, lactones, nitriles, sulfones, ethers, phosphates, and ionic liquids. The electrolyte additive is selected from a group consisting of 1,3,2-dioxathiolane 2,2-dioxide (DTD), vinyl ethylene carbonate (VEC), vinylene carbonate (VC), fluorosulfonyl isocyanate (FI), trimethyl borate (TMB), tris(trimethylsilyl) phosphate (TTSPi), methylene methane disulfonate (MMDS), and prop-1-ene-1,3-sultone (PES).

In other features, the method includes heating the tank to a first temperature in a range from 100 to 250° C. The method includes heating the slot die a second temperature in a range from 100 to 250° C. The gel membrane is cooled by dry gas at a temperature in a range from 10 to 60° C. The polymer includes polyacrylonitrile (PAN) and the liquid electrolyte includes LiTFSI, LiBF₄, ethylene carbonate (EC), and γ-butyrolactone (GBL).

A battery cell, comprises a cathode electrode comprising a cathode current collector and cathode active material configured to exchange lithium ions. An anode electrode comprises an anode current collector and anode active material configured to exchange lithium ions. A gel membrane is arranged between the cathode electrode and the anode electrode and comprises a polymer and a liquid electrolyte comprising a dual lithium salt, a dual solvent, and an electrolyte additive.

In other features, the polymer is in a range from 10 to 50 wt % of the gel membrane and the liquid electrolyte is in a range from 50 to 90 wt % of the gel membrane. The polymer is selected from a group consisting of poly(ethylene oxide) (PEO), poly(vinylidene fluoride-co-hexafluoropropylene) (PVdF-HFP), poly(methyl methacrylate) (PMMA), carboxymethyl cellulose (CMC), polyacrylonitrile (PAN), polyvinylidene difluoride (PVDF), poly(vinyl alcohol) (PVA), and polyvinylpyrrolidone (PVP).

In other features, the dual lithium salt comprises at least one lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxylate)borate (BOB), difluoro(oxolate)borate (DFOB), and bis(fluoromalonato)borate (BFMB).

In other features, the dual solvent is selected from a group consisting of carbonate solvents, lactones, nitriles, sulfones, ethers, phosphates, and ionic liquids.

In other features, the electrolyte additive is selected from a group consisting of 1,3,2-dioxathiolane 2,2-dioxide (DTD), vinyl ethylene carbonate (VEC), vinylene carbonate (VC), fluorosulfonyl isocyanate (FI), trimethyl borate (TMB), tris(trimethylsilyl) phosphate (TTSPi), methylene methane disulfonate (MMDS), and prop-1-ene-1,3-sultone (PES).

In other features, the polymer includes polyacrylonitrile (PAN), the dual lithium salt includes LiTFSI and LiBF₄, and the dual solvent includes ethylene carbonate (EC) and γ-butyrolactone (GBL).

In other features, a solid electrolyte layer arranged between the cathode electrode and the anode electrode.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of an example of a solid-state battery;

FIGS. 2A and 2B are side cross-sectional views of an example of a solid-state battery including a gel membrane according to the present disclosure;

FIG. 3 is a side cross-sectional view of another example of a conventional battery including a gel membrane according to the present disclosure; and

FIG. 4 illustrates a method for roll-to-roll hot casting of an example of a gel membrane according to the present disclosure.

In the drawings, reference numbers may be reused to identify similar and/or identical elements.

### DETAILED DESCRIPTION

While the battery cells according to the present disclosure are described below in the context of a vehicle, the battery cells according to the present disclosure can be used in other applications.

Solid-state battery (SSB) cells with solid electrolyte (SE) have improved characteristics as compared to LIB cells in terms of abuse tolerance, and working temperature range. The SE may include oxides having high ionic conductivity and good oxidative stability. However, oxide SE is rigid and physical contact between the oxide SE layer and the surrounding electrode layers is poor due to high interfacial resistance. In addition, the physical contact is gradually weakened due to volumetric change of electrode material during cycling. As a result, performance deteriorates with use.

A free-standing gel membrane according to the present disclosure has high ionic conductivity and good stretching ability. The gel membrane provides favorable electrode/electrolyte interfacial contact and endows the battery cell with excellent power capability and cyclability. The gel membrane can be fabricated using roll-to-roll hot casting of a gel precursor solution. In some examples, the gel precursor solution comprises a polymer, a dual salt, and a dual solvent. In some examples, the polymer includes polyacrylonitrile (PAN), the dual salt includes LiTFSI and LiBF₄, and the dual solvent includes ethylene carbonate (EC) and γ-butyrolactone (GBL), although other compositions are described further below.

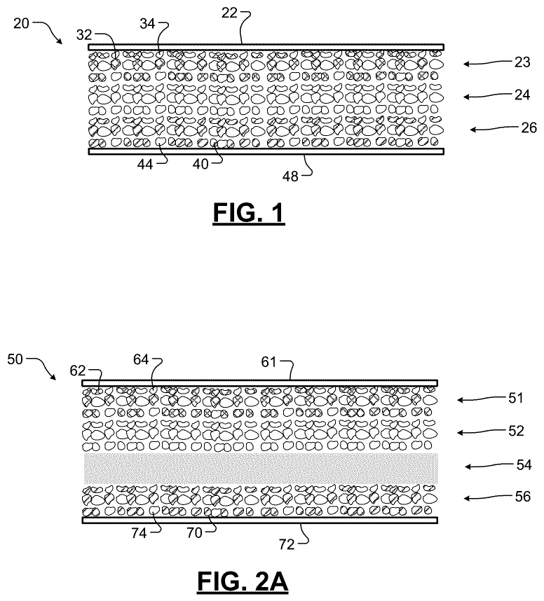

Referring now to FIG. 1, an SSB 20 includes a cathode electrode 23, a solid electrolyte layer 24, and an anode electrode 26. The solid electrolyte layer 24 is sandwiched between the cathode electrode 23 and the anode electrode 26. The cathode electrode 23 includes a current collector 22 and cathode active material 32. Solid electrolyte 34 may fill areas of the cathode active material 32. The anode electrode 26 includes current collector 48 and anode active material 40. Solid electrolyte 44 may fill areas between the anode active material 40.

When the solid electrolyte layer 24 includes oxide SE, performance of the battery cell suffers. Oxide SE is normally rigid and has a large grain boundary resistance which leads to poor solid-solid interfacial contact and poor power capability. Some oxides (such as LATP) cannot directly work with low operating voltage anodes (such as graphite) due to its high reductive limit (e.g., 1.7V). After cycling, the volumetric changes of the electrode active material further deteriorate the interfacial contact and reduce cycling performance.

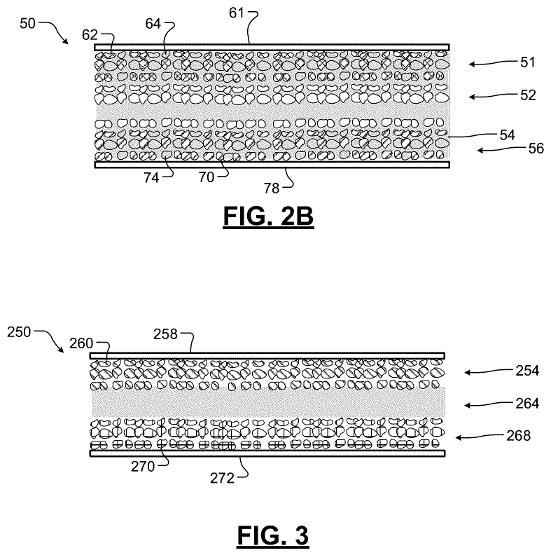

Referring now to FIGS. 2A and 2B, a gel membrane according to the present disclosure is added to a battery cell including a solid electrolyte layer to improve interfacial contact. In FIG. 2A, an SSB 50 includes a cathode electrode 51, a solid electrolyte layer 52, a gel membrane 54, and the anode electrode 56. The cathode electrode 51 includes a current collector 61 and cathode active material 62. Solid electrolyte 64 may be mixed with the cathode active material 62. The anode electrode 56 includes a current collector 78 and anode active material 70. Solid electrolyte 74 may be mixed with the anode active material 70.

In FIG. 2B, part of the gel membrane 54 infiltrates the cathode electrode 53, solid electrolyte layer 52, and the anode electrode 56 after pressing and/or heating. The gel membrane 54 is a soft, high-ionic conductivity, free-standing membrane that ameliorates the electrode/electrolyte interface, improves interfacial contact, improves battery cyclability, and power capability.

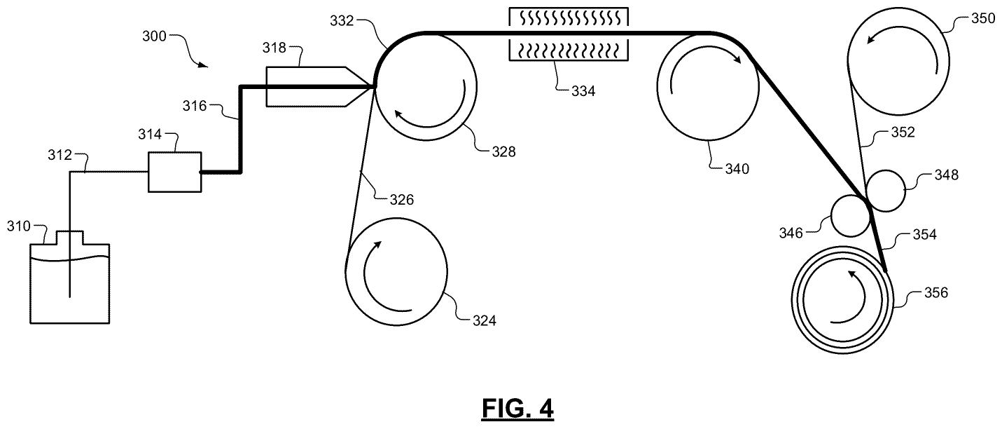

Referring now to FIG. 3, the gel membrane described herein can also be used in a conventional lithium-ion battery as a separator. A lithium-ion battery cell 250 includes a cathode electrode 254, a gel membrane 264 acting as a separator, and an anode electrode 268. The cathode electrode 254 includes a current collector 258 and cathode active material 260. The anode electrode 268 includes a current collector 272 and anode active material 270.

Referring now to FIG. 4, a roll-to-roll manufacturing process for the gel membrane 54 is shown. A tank 310 stores a gel membrane solution. In some examples, the gel membrane solution is heated in the tank 310 to a temperature in a range from 100° C. to 250° C.

A conduit 312 connects the tank 310 to an inlet of a pump 314. An outlet of the pump 314 supplies the gel membrane solution via a conduit 316 to an inlet of a slot die 318. A substrate roller 324 supplies a substrate 326 (e.g., a polymer film) onto a roller 328. The substrate 326 is used to prevent sticking between layers of the gel membrane as it is cooled and dried. An outlet of the slot die 318 applies a thin layer of the gel membrane solution onto the substrate 326 supported by a roller 328. In some examples, the slot die 318 is heated to a temperature in a range from 100° C. to 250° C. with a gap between the slot die 318 and the roller 322 in a range from 1 μm to 100 μm.

The gel membrane can be cooled naturally in atmospheric conditions and/or cooled using a cooling device 334. In some examples, the substrate and the gel membrane (collectively identified at 332) pass through the cooling device 334 and are cooled and fully or partially solidified by the cooling device 334. In some examples, the cooling device 334 chills the gel membrane using cooled gas such as dry air at a temperature in a predetermined range from 10° C. to 60° C.

The substrate and the gel membrane 332 are guided by a roller 340 between rollers 346 and 348. A substrate roller 350 supplies a substrate 352 (e.g., such as polymer film) between the rollers 346 and 348. In other words, the gel membrane is sandwiched between the substrate 326 and the substrate 352 (collectively identified at 354) to prevent sticking. The substrate 326, the gel membrane, and the substrate 352 are wound onto a roller 356. Prior to usage of the gel membrane in a battery cell, the substrate 326 and the substrate 352 are removed.

Battery cells including the gel membrane according to the present disclosure have improved ionic conductivity, capacity retention, and capacity. As can be appreciated, roll-to-roll hot casting of the membrane is scalable and can be used to continuously manufacture the gel membrane.

In some examples, the gel membrane solution comprises a polymer in a range from 0.1 to 50 wt % and a liquid electrolyte in a range from 50 to 90 wt %. In some examples, the liquid electrolyte includes a mixture including a dual lithium salt, a dual solvent, and electrolyte additives. In some examples, the liquid electrolyte includes a dual lithium salt including 0.1 to 2.0M LiTFSI and 0.1 to 2.0 M LiBF₄. In some examples, the dual solvent includes ethylene carbonate (EC) and γ-butyrolactone (GBL) equal to (10-x):x(w/w, 0.5<x<9.5)]%. In some examples, the electrolyte additive is in a range from 0 to 10 wt %. In some examples, the gel membrane solution comprises 13 wt % PAN, 87 wt % [0.4M LiTFSI, 0.4M LiBF₄ in EC/GBL=4:6 (w/w)].

In some examples, the polymer is selected from a group consisting of poly(ethylene oxide) (PEO), poly(vinylidene fluoride-co-hexafluoropropylene) (PVdF-HFP), poly(methyl methacrylate) (PMMA), carboxymethyl cellulose (CMC), polyacrylonitrile (PAN), polyvinylidene difluoride (PVDF), poly(vinyl alcohol) (PVA), and polyvinylpyrrolidone (PVP).

In some examples, the dual lithium salt comprises at least lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalate)borate (DFOB), and bis(fluoromalonato)borate (BFMB).

The solvent in the gel membrane dissolves the lithium solvent to enable good lithium-ion conductivity and relatively low vapor pressure to match the fabrication process. In some examples, the solvent comprises carbonate solvents, lactones, nitriles, sulfones, ethers, phosphates, and ionic liquids.

Examples of carbonate solvents include ethylene carbonate (EC), propylene carbonate (PC), glycerol carbonate, vinylene carbonate, fluoroethylene carbonate, and 1,2-butylene carbonate. Examples of lactones include γ-butyrolactone (GBL) and δ-valerolactone. Examples of nitriles include succinonitrile, glutaronitrile, and adiponitrile. Examples of sulfones include tetramethylene sulfone, ethyl methyl sulfone, vinyl sulfone, phenyl sulfone, 4-fluorophenyl sulfone, and benzyl sulfone. Examples of ethers include triethylene glycol dimethylether (triglyme, G3), tetraethylene glycol dimethylether (tetraglyme, G4), 1,3-dimethoxy propane, and 1,4-dioxane. Examples of phosphates include triethyl phosphate and trimethyl phosphate.

Examples of ionic liquids include ionic liquid cations and ionic liquid anions. Examples of ionic liquid cations include 1-ethyl-3-methylimidazolium [Emim]⁺, 1-propyl-1-methylpiperidinium [PP₁₃]⁺, 1-butyl-1-methylpiperidinium [PP₁₄]⁺, 1-methyl-1-ethylpyrrolidinium [Pyr₁₂]⁺, 1-propyl-1-methylpyrrolidinium [Pyr₁₃]⁺, and 1-butyl-1-methylpyrrolidinium [Pyr₁₄]⁺. Examples of ionic liquid anions include bis(fluorosulfonyl)imide (FSI) and bis(trifluoromethanesulfonyl)imide (TFSI).

In some examples, the electrolyte additive is selected from a group consisting of 1,3,2-dioxathiolane 2,2-dioxide (DTD), vinyl ethylene carbonate (VEC), vinylene carbonate (VC), fluorosulfonyl isocyanate (FI), trimethyl borate (TMB), tris(trimethylsilyl) phosphate (TTSPi), methylene methane disulfonate (MMDS), and prop-1-ene-1,3-sultone (PES).

In some examples, the cathode active material is selected from a group consisting of rock salt layered oxides, spinel, polyanion cathode materials, and surface-coated and/or doped cathode materials. Examples of rock salt layered oxides include LiCoO₂, LiNiₓMn_{y}Co_{1-x-y}O₂, LiNiₓMn_{y}Al_{1-x-y}O₂, LiNiₓMn₁₋ₓO₂, and Li₁₊ₓMO₂. Examples of spinel include LiMn₂O₄, LiNi_{0.5}Mn_{1.5}O₄. Examples of polyanion cathode include LiV₂(PO₄)₃). In other examples, the cathode active material includes other lithium transition-metal oxides. Surface-coated and/or doped cathode materials such as LiNbO₃-coated LiMn₂O₄, Li₂ZrO₃ or Li₃PO₄-coated LiNiₓMn_{y}Co_{1-x-y}O₂, and Al-doped LiMn₂O₄. In other examples, low voltage cathode material such as lithiated metal oxide/sulfide (e.g., LiTiS₂), lithium sulfide, or sulfur can be used.

In some examples, the conductive additive is selected from a group consisting of carbon black, graphite, graphene, graphene oxide, Super P, acetylene black, carbon nanofibers, carbon nanotubes and other electronically conductive additives.

In some examples, the solid electrolyte is selected from a group consisting of oxide-based solid electrolyte, metal-doped or aliovalent substituted oxide solid electrolyte, sulfide-based solid electrolyte, nitride-based solid electrolyte, hydride-based solid electrolyte, halide-based solid electrolyte, borate-based solid electrolyte, and inactive ceramic oxides.

Examples of oxide-based solid electrolytes include garnet type (e.g., Li₇La₃Zr₂O₁₂), perovskite type (e.g., Li₃ₓLa_{2/3-x}TiO₃), NASICON type (e.g., Li_{1.4}Al_{0.4}Ti_{1.6}(PO₄)₃ and Li₁₊ₓAlₓGe₂₋ₓ(PO₄)₃), and LISICON type (e.g., Li₂₊₂ₓZn₁₋ₓGeO₄).

Examples of metal-doped or aliovalent substituted oxide solid electrolytes include Al or Nb-doped Li₇La₃Zr₂O₁₂, Sb-doped Li₇La₃Zr₂O₁₂, Ga-substituted Li₇La₃Zr₂O₁₂, Cr and V-substituted Li₇La₃Zr₂O₁₂, Al-substituted perovskite, and Li_{1+x+y}AlₓTi₂₋ₓSi_{y}P_{3-y}O₁₂.

In some examples, the sulfide-based solid electrolyte is selected from a group consisting of pseudobinary sulfide, pseudoternary sulfide, and pseudoquaternary sulfide. Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, 0.4·0.6Li₄SnS₄ and Li₁₁Si₂PS₁₂. Examples of pseudoquaternary sulfide include Li₂O—Li₂S—P₂S₅—P₂O₅ system, Li_{9.54}S_{11.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

Examples of nitride-based solid electrolyte includes Li₃N, Li₇PN₄, and LiSi₂N₃.

Examples of halide-based solid electrolyte includes Li₃YCl₆, Li₃InCl₆, Li₃YBr₆, LiI, Li₂CdCl₄, Li₂MgCl₄, Li₂CdI₄, Li₂ZnI₄, Li₃OCl. Examples of hydride-based solid electrolyte include LiBH₄, LiBH₄—LiX (X=Cl, Br, or I), LiNH₂, Li₂NH, LiBH₄—LiNH₂, Li₃AlH₆.

Examples of borate based solid electrolyte include Li₂B₄O₇, Li₂B₄O₇, and Li₂O—B₂O₃—P₂O₅.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a gel membrane for a battery cell, comprising:
supplying a first substrate to a first roller;
heating a gel membrane solution in a tank, wherein the gel membrane solution includes a polymer and a liquid electrolyte comprising one or more lithium salts;
arranging a slot die within a predetermined distance of the first substrate located on the first roller;
pumping the gel membrane solution into an inlet of the slot die;
depositing a gel membrane layer from an outlet of the slot die onto the first substrate supported by the first roller; and
cooling the gel membrane layer on the first substrate.

2. The method of claim 1, wherein a gap between the outlet of the slot die and the first substrate is in a range from 1 μm to 100 μm.

3. The method of claim 1, further comprising arranging a second substrate over an exposed surface of the gel membrane layer.

4. The method of claim 3, wherein the polymer is in a range from 10 to 50 wt % of the gel membrane solution and the liquid electrolyte is in a range from 50 to 90 wt % of the gel membrane solution.

5. The method of claim 4, wherein the polymer is selected from a group consisting of poly(ethylene oxide) (PEO), poly(vinylidene fluoride-co-hexafluoropropylene) (PVdF-HFP), poly(methyl methacrylate) (PMMA), carboxymethyl cellulose (CMC), polyacrylonitrile (PAN), polyvinylidene difluoride (PVDF), poly(vinyl alcohol) (PVA), and polyvinylpyrrolidone (PVP).

6. The method of claim 4, wherein the liquid electrolyte comprises a dual lithium salt, a solvent, and an electrolyte additive.

7. The method of claim 6, wherein the dual lithium salt comprises at least one lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalate)borate (DFOB), and bis(fluoromalonato)borate (BFMB).

8. The method of claim 6, wherein the solvent is selected from a group consisting of carbonate solvents, lactones, nitriles, sulfones, ethers, phosphates, and ionic liquids.

9. The method of claim 6, wherein the electrolyte additive is selected from a group consisting of 1,3,2-dioxathiolane 2,2-dioxide (DTD), vinyl ethylene carbonate (VEC), vinylene carbonate (VC), fluorosulfonyl isocyanate (FI), trimethyl borate (TMB), tris(trimethylsilyl) phosphate (TTSPi), methylene methane disulfonate (MMDS), and prop-1-ene-1,3-sultone (PES).

10. The method of claim 1, further comprising:
heating the tank to a first temperature in a range from 100 to 250° C.; and
heating the slot die a second temperature in a range from 100 to 250° C.

11. The method of claim 1, wherein the gel membrane is cooled by dry gas at a temperature in a range from 10 to 60° C.

12. The method of claim 1, wherein the polymer includes polyacrylonitrile (PAN) and the liquid electrolyte includes LiTFSI, LiBF₄, ethylene carbonate (EC), and γ-butyrolactone (GBL).

13. A battery cell, comprising:
a cathode electrode comprising a cathode current collector and cathode active material configured to exchange lithium ions;
an anode electrode comprising an anode current collector and anode active material configured to exchange lithium ions; and
a gel membrane arranged between the cathode electrode and the anode electrode and comprising a polymer and a liquid electrolyte comprising a dual lithium salt, a dual solvent, and an electrolyte additive.

14. The battery cell of claim 13, wherein the polymer is in a range from 10 to 50 wt % of the gel membrane and the liquid electrolyte is in a range from 50 to 90 wt % of the gel membrane.

15. The battery cell of claim 13, wherein the polymer is selected from a group consisting of poly(ethylene oxide) (PEO), poly(vinylidene fluoride-co-hexafluoropropylene) (PVdF-HFP), poly(methyl methacrylate) (PMMA), carboxymethyl cellulose (CMC), polyacrylonitrile (PAN), polyvinylidene difluoride (PVDF), poly(vinyl alcohol) (PVA), and polyvinylpyrrolidone (PVP).

16. The battery cell of claim 13, wherein the dual lithium salt comprises at least one lithium cation and at least one anion selected from a group consisting of hexafluoroarsenate, hexafluorophosphate, bis(fluorosulfonyl)imide (FSI), perchlorate, tetrafluoroborate, cycle-difluoromethane-1,1-bis(sulfonyl)imide (DMSI), bis(trifluoromethanesulfonyl)imide (TFSI), bis(perfluoroethanesulfonyl)imide (BETI), bis(oxylate)borate (BOB), difluoro(oxolate)borate (DFOB), and bis(fluoromalonato)borate (BFMB).

17. The battery cell of claim 13, wherein the dual solvent is selected from a group consisting of carbonate solvents, lactones, nitriles, sulfones, ethers, phosphates, and ionic liquids.

18. The battery cell of claim 13, wherein the electrolyte additive is selected from a group consisting of 1,3,2-dioxathiolane 2,2-dioxide (DTD), vinyl ethylene carbonate (VEC), vinylene carbonate (VC), fluorosulfonyl isocyanate (FI), trimethyl borate (TMB), tris(trimethylsilyl) phosphate (TTSPi), methylene methane disulfonate (MMDS), and prop-1-ene-1,3-sultone (PES).

19. The battery cell of claim 13, wherein the polymer includes polyacrylonitrile (PAN), the dual lithium salt includes LiTFSI and LiBF₄, and the dual solvent includes ethylene carbonate (EC) and γ-butyrolactone (GBL).

20. The battery cell of claim 13, further comprising a solid electrolyte layer arranged between the cathode electrode and the anode electrode.
